(19) United States
(12) Patent Application Publication
(10) Pub. No.: US 2012/0089286 A1
(43) Pub. Date: Apr. 12, 2012

(54) VEHICLE CONTROL SYSTEM AND AUTOMOBILE

(76) Inventor: Hideki Nakata, Osaka (JP)

(21) Appl. No.: 13/377,001

(22) PCT Filed: Jun. 25, 2010
(86) PCT No.: PCT/JP2010/004244

§ 371 Date: Dec. 8, 2011

(30) Foreign Application Priority Data
Jun. 25, 2009 (JP) 2009-150619

(51) Int. Cl. G06F 7/00

(52) U.S. Cl. 701/22

(57) ABSTRACT

A vehicle control system includes: a chemical storage unit 110 such as a lithium ion battery; a physical storage unit 120 such as a capacitor; an inverter 140 that is driven upon receiving a direct current from the storage units 110 and 120; and a motor 150 that is driven upon receiving an alternating current output from the inverter 140. The vehicle control system comprises: a position determination unit 180 for determining, based on present position information acquired by a present position information acquisition unit 170, whether a vehicle is approaching a parking position indicated by parking position information 161; and a control unit 190 for, when the vehicle is determined to be approaching the parking position, controlling the use of the electric power of the physical storage unit 120, such as charging the chemical storage unit 110 with electric power from the physical storage unit 120.

### TECHNICAL FIELD

The present invention relates to a vehicle control system for controlling a vehicle that moves by an electric motor with a storage battery being a main power source, and an automobile in which the vehicle control system is mounted.

### TECHNICAL FIELD

In recent years, environmentally friendly automobiles, such as electric cars that move by the drive force of a motor, hybrid cars that move by the drive force of an engine and a motor, etc., have been a focus of attention. Such an automobile includes an electric storage mechanism including a secondary battery, an electric double-layer capacitor, and the like. The power of the secondary battery is stored in the electric double-layer capacitor, and the power of the electric double-layer capacitor is used for driving the motor. Also, at the time of a regenerative operation, the kinetic energy of the automobile is converted to an electric energy and stored in the electric double-layer capacitor. The discharge operation from the electric storage mechanism or the charge operation to the electric storage mechanism is performed in consideration of the remaining voltage of the secondary battery and the electric double-layer capacitor.

Meanwhile, if the electric double-layer capacitor is left for a long time with its remaining voltage being high, self-discharge of the electric double-layer occurs. In this case, for example, the remaining voltage of the electric double-layer capacitor decreases over time, resulting in the electric energy stored therein being wasted, as shown in FIG. 14.

In order to reduce the waste in the electric energy, Patent Literature 1 discloses a power control unit having the following structure. That is, when a predetermined time period elapses after a vehicle stops, the power control unit detects the remaining voltage of a capacitor. If the remaining voltage is greater than or equal to a predetermined voltage, the power control unit charges an auxiliary battery with electric power from the capacitor.

### CITATION LIST

### Patent Literature

[Patent Literature 1]
Japanese Patent Application Publication No. 2000-156919

### SUMMARY OF INVENTION

### Technical Problem

However, according to Patent Literature 1, the remaining voltage of the capacitor is detected when the predetermined time period elapses after the vehicle stops and, if the remaining voltage is greater than or equal to a predetermined voltage, the auxiliary battery is charged with electric power from the capacitor. This poses a problem where self-discharge of the capacitor occurs even during the predetermined time period.

One possible approach to solve the problem is to detect the remaining voltage of the capacitor as soon as the vehicle stops, and to supply electric power from the capacitor to the auxiliary battery if the remaining voltage is greater than or equal to the predetermined voltage. In this case, however, charging from the capacitor to the auxiliary battery is performed every time the vehicle stops. This frequent charging of the auxiliary battery causes the life of the auxiliary battery to be shortened.

The present invention has been achieved in view of the above problem, and an aim thereof is to provide a vehicle control system for minimizing an energy loss caused by self-discharge of a capacitor and preventing the life of a secondary battery from being wastefully shortened, and an automobile including the vehicle control system.

### Solution to Problem

In order to solve the above problem, the present invention provides a vehicle control system including: a chemical storage unit; a physical storage unit; and a charge and discharge circuit connected between the chemical storage unit and the physical storage unit and transferring electric power therebetween, the vehicle control system comprising: a parking position information storage unit capable of storing therein at least one parking position information piece indicating a parking position of a vehicle in which the vehicle control system is mounted; a present position information acquisition unit configured to sequentially acquire present position information pieces each indicating a present position of the vehicle; a position determination unit configured to determine whether a distance between the present position and the parking position is less than or equal to a predetermined distance; and a control unit configured, when the position determination unit determines affirmatively, to control use of the electric power of the physical storage unit before the vehicle arrives at the parking position.

Here, the chemical storage unit is a secondary battery that stores electric power with use of a chemical reaction. For example, the chemical storage unit may be a lead-acid battery, a nickel hydride battery, a lithium ion battery, etc.

Also, the physical storage unit stores electric power with use of absorption and desorption of electrons and ions with respect to an electrode. For example, the physical storage unit may be an electric double-layer capacitor.

### Advantageous Effects of Invention

With the stated structure, the control unit controls the use of the electric power of the physical storage unit when the vehicle in which the vehicle control system is mounted approaches the parking position indicated by the parking position information piece. Accordingly, by the time the vehicle stops, the voltage of the physical storage unit is reduced. In general, the lower the remaining voltage of the physical storage unit is, the less likely self-discharge thereof is to occur and the smaller the amount of discharge thereof is. Therefore, self-discharge of the physical storage unit is less likely to occur after the vehicle stops, resulting in an energy loss being more efficiently suppressed than in the conventional technologies. Also, suppose that the electric power of the physical storage unit is used to charge the chemical storage unit. Even in such a case, the control of the use of the electric power of the physical storage unit is performed only when the vehicle approaches a predetermined parking position. This prevents charging from being performed every time the vehicle stops, thus preventing the life of the chemical storage unit from being wastefully shortened.

### BRIEF DESCRIPTION OF DRAWINGS

FIG. 1 shows the structure of a vehicle control system according to Embodiment 1.

FIG. 2 is a data schematic view showing an example of the structure of parking position information.

FIG. 3 is a flowchart showing an operation of a control unit performed when a vehicle approaches a parking position according to Embodiment 1.

FIG. 4 is a flowchart showing an operation of a setting unit, the operation pertaining to setting and deleting parking position information according to Embodiment 1.

FIG. 5 is a flowchart showing an operation performed by the control unit when new parking position information is set by the setting unit according to Embodiment 1.

FIG. 6 shows the structure of a vehicle control system according to Embodiment 2.

FIG. 7 shows the structure of a vehicle control system according to Embodiment 3.

FIG. 8 is a flowchart showing a control operation of the vehicle control system according to Embodiment 3.

FIG. 9 shows the structure of a vehicle control system according to Embodiment 4.

FIG. 10 is a graph showing an example of a transition of electric power used by the vehicle control system and a transition of voltage of a capacitor.

FIG. 11 is a data schematic view showing arrival power information showing amounts of electric power necessary for arriving at respective parking positions according to Embodiment 4.

FIG. 12 is a flowchart showing an operation of the vehicle control system according to Embodiment 4.

FIG. 13 shows the structure of an automobile according to Embodiment 5.

FIG. 14 is a graph showing a reduction in voltage caused by self-discharge of a capacitor.

### DESCRIPTION OF EMBODIMENTS

The following describes a vehicle control system and an automobile according to an embodiment of the present invention, with reference to the drawings.

### Embodiment 1

<Structure>

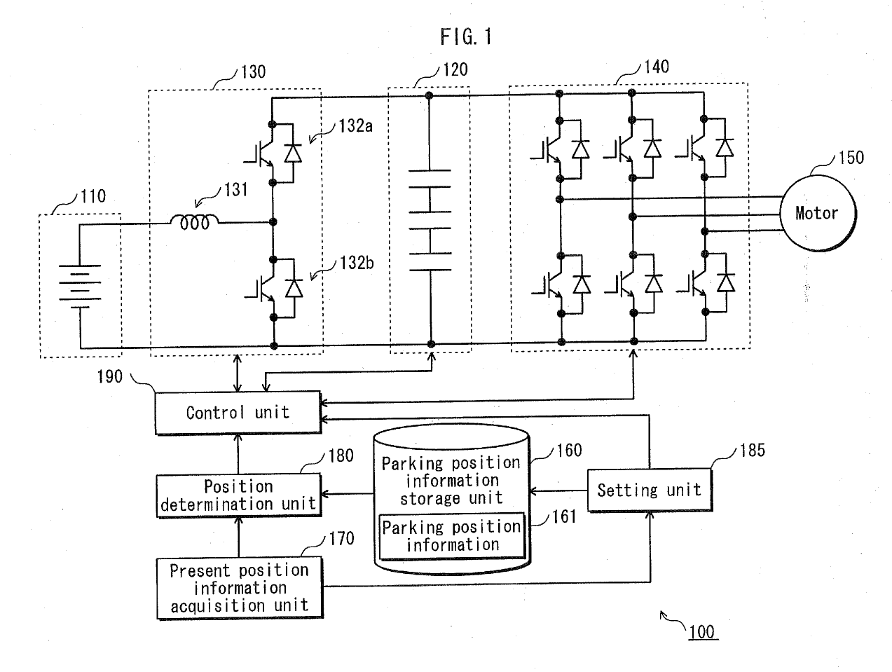

FIG. 1 shows the structure of a vehicle control system 100 according to Embodiment 1.

As shown in FIG. 1, the vehicle control system 100 includes a chemical storage unit 110, a physical storage unit 120, a charge and discharge circuit 130, an inverter 140, a motor 150, a parking position information storage unit 160, a present position information acquisition unit 170, a position determination unit 180, a setting unit 185, and a control unit 190.

The chemical storage unit 110 is a secondary battery that stores electric power by a chemical reaction, and is realized by a nickel hydride battery, a lithium-ion battery, a lithium polymer battery, or the like.

The physical storage unit 120 stores electric power by absorption and desorption of electrons and ions with respect to an electrode, and is realized by an electric double-layer capacitor or the like. The electric double-layer capacitor may be referred to as an ultracapacitor or a supercapacitor. In recent years, a capacitor using a carbon nanotube has been a focus of attention.

The charge and discharge circuit 130 switches on and off switching devices 132a and 132b according to an instruction from the control unit 190, thereby supplying electric power from the chemical storage unit 110 to the physical storage unit 120 and the inverter 140, and supplying electric power from the physical storage unit 120 to the chemical storage unit 110. Hereinafter, electric power supply from the chemical storage unit 110 to the physical storage unit 120 is sometimes referred to as a discharge operation, and electric power supply from the physical storage unit 120 to the chemical storage unit 110 is sometimes referred to as a charge operation.

The charge and discharge circuit 130 includes an inductor 131, and the switching devices 132a and 132b.

First, a discharge operation in the charge and discharge circuit 130 is described.

When the voltage across the physical storage unit 120 is lower than the voltage across the chemical storage unit 110, an electric current flows via the inductor 131 and a diode arranged parallel to the switching device 132a. Therefore, regardless of whether the switching devices 132a and 132b of the charge and discharge circuit 130 are switched on or off, the voltage across the physical storage unit 120 is maintained to be higher than the voltage across the chemical storage unit 110. In the case of raising the voltage across the physical storage unit 120 higher than the voltage across the chemical storage unit 110, the control unit 190 performs PWM (Pulse Width Modulation) control or the like to cause the switching device 132b to be switched on and off. In other words, the charge and discharge circuit 130 in this case functions as a booster circuit.

On the other hand, in the case of a charge operation, the switching device 132a is switched on and off by the PWM control of the control unit 190. In this way, an electric current flows from the physical storage unit 120 to the chemical storage unit 110 via the switching device 132a and the inductor 131, and accordingly electric power is supplied from the physical storage unit 120 to the chemical storage unit 110, i.e., the chemical storage unit 110 is charged. When the switching device 132a is switched on, and if the voltage across the physical storage unit 120 is higher than the voltage across the chemical storage unit 110, the charge current increases. When the switching device 132a is switched off, an electric current flowing through the inductor 131 is decreased. At this time, an electric current continues to flow through the inductor 131 via a diode arranged parallel to the switching device 132b. Accordingly, if an electric current flowing through the inductor 131 is larger than a current command value designated by the control unit 190, an ON duty ratio of the switching device 132a (i.e., a ratio at which the switching device 132a is switched on per unit time) is decreased. On the other hand, if an electric current flowing through the inductor 131 is smaller than the current command value, the ON duty ratio of the switching device 132a is increased.

The inverter 140 supplies an alternating current to the motor 150 for moving a vehicle in which the vehicle control system 100 is mounted, with either the chemical storage unit 110 or the physical storage unit 120 being the voltage source. The inverter 140 mainly uses the physical storage unit 120 as the voltage source. The inverter 140 receives a direct current from the physical storage unit 120, generates a three-phase alternating current from the direct current by switching on and off switching devices with the PWM control by the control unit 190, and outputs the three-phase alternating current to the motor 150. Also, the inverter 140 causes the torque of the motor 150 to be reduced, and thereby converts the kinetic energy of the vehicle into electric energy to charge the physical storage unit 120. Since it is conventionally known that a switching operation is performed to generate an alternating current from a direct current, a detailed description of the switching operation is omitted.

The motor 150 is a so-called three-phase motor, and rotates upon receiving an alternating current from the inverter 140. The motor 150 drives wheels of the vehicle in which the vehicle control system 100 is mounted.

The parking position information storage unit 160 is a recording medium realized by a nonvolatile HDD (Hard Disc Drive), a flash memory, or the like, and stores thereon parking position information 161. The parking position information 161 lists one or more parking positions pertaining to a condition for the vehicle control system 100 to control the use of the electric power of the physical storage unit 120. Details of the parking position information 161 are described later. Each parking position registered in the parking position information 161 is a destination at which the vehicle is to be parked. For example, the destination may be a home of the owner of the vehicle.

The present position information acquisition unit 170 is realized by a GPS (Global Positioning System), for example. The present position information acquisition unit 170 sequentially (e.g., every 5 seconds) acquires present position information (i.e., latitude and longitude) of the vehicle in which the vehicle control system 100 is mounted, and transmits the present position information to the position determination unit 180 and the setting unit 185.

Every time the position determination unit 180 receives present position information from the present position information acquisition unit 170, the position determination unit 180 calculates the distance between the coordinates indicated by the present position information and the coordinates of each parking position registered in the parking position information 161, and determines, for each distance thus calculated, whether the distance is less than or equal to a predetermined distance Dis. If any of the distances is less than or equal to the predetermined distance Dis, the position determination unit 180 notifies the control unit 190 to that effect. Note that the predetermined distance Dis is a distance that allows sufficient time for performing a charge operation from the physical storage unit 120 to the chemical storage unit 110 at a charge current that does not cause damage or deterioration of the chemical storage unit 110, and thereby lowering the voltage of the physical storage unit 120 to a voltage Vs or lower at which self-discharge of the physical storage unit 120 is suppressed.

Here, suppose that the position determination unit 180 determines that the vehicle has approached any of the parking positions and, before the vehicle stops at the parking position, the distance between the parking position and the present position of the vehicle, which is indicated by the present position information sequentially received from the present position information acquisition unit 170, becomes greater than or equal to the predetermined distance Dis. In this case, the position determination unit 180 notifies the control unit 190 that the vehicle has moved away from the parking position.

The setting unit 185 registers parking position information indicating a new parking position into the parking position information 161 stored in the parking position information storage unit 160. Also, the setting unit 185 deletes parking position information from the parking position information 161.

The setting unit 185 is connected to, for example, a car navigation system (not shown in FIG. 1) or the like. With respect to a map displayed on a touch panel of the car navigation system, a user designates a parking position as parking position information. Upon receiving an input of the parking position via the car navigation system, the setting unit 185 additionally registers, as new parking position information, the latitude and longitude of the parking position into the parking position information 161. Also, the setting unit 185 records the history of pieces of present position information received from the present position information acquisition unit 170. If the present position indicated by each piece of present position information is equivalent for greater than or equal to a predetermined time period (e.g., greater than or equal to 24 hours), the setting unit 185 registers the present position as a new parking position into the parking position information 161, and notifies the control unit 190 of the registration of the new parking position.

Also, upon receiving an input from the user regarding parking position information to be deleted, the setting unit 185 deletes the parking position information from the parking position information 161, as described above. Furthermore, if any of the parking positions indicated by the parking position information 161 does not match the present position indicated by the present position information for greater than or equal to a predetermined time period (e.g., one week), the setting unit 185 deletes the parking position information corresponding to the parking position from the parking position information 161.

The control unit 190 controls the charge and discharge circuit 130 and the inverter 140. Also, the control unit 190 detects the remaining voltage of the physical storage unit 120.

First, a description is provided of a charge control and a discharge control realized by the control unit 190 controlling the switching devices in the charge and discharge circuit 130.

When giving a charge instruction, the control unit 190 arbitrarily determines a charge current value (i.e., the value of an electric current supplied to the chemical storage unit 110) within the range in which the chemical storage unit 110 is not damaged or deteriorated. The control unit 190 performs feedback control so that the average of charge current values becomes a current command value. The current command value is within the range in which the chemical storage unit 110 is not damaged or deteriorated during a charge operation by the control unit 190, and is either generated, stored in advance, or acquired from outside the system. The control unit 190 detects the value of an electric current flowing through the inductor 131, and amplifies a difference between the detected value and the current command value using proportional control, proportional-plus-integral control, or the like. Then, based on a result of calculation performed for the difference amplification, the control unit 190 causes the switching device 132a to be on and off using the PWM control or the like.

A current command value, which is used when the switching device 132b is switched on and off, is determined based on a target voltage of the physical storage unit 120 in a manner that the current command value falls within the range in which a discharge current output from the chemical storage unit 110 does not damage or deteriorate the chemical storage unit 110 itself. In other words, the control unit 190 detects the actual value of the voltage of the physical storage unit 120, and amplifies a difference between the detected value and the value of the target voltage of the physical storage unit 120 using proportional control, proportional-plus-integral control, or the like. Then, based on a result of calculation performed for the difference amplification, the control unit 190 causes the switching device 132b to be on and off using the PWM control or the like. At this time, the control unit 190 detects the value of the discharge current of the chemical storage unit 110, and decreases the ON duty ratio of the switching device 132b as necessary, so as to protect the chemical storage unit 110 against overcurrent output which damages or deteriorates the chemical storage unit 110. In this way, a voltage higher than the voltage across the chemical storage unit 110 is applied to the physical storage unit 120.

Next, a control of the inverter 140 performed by the control unit 190 is described. The control unit 190 causes the switching devices in the inverter 140 to be switched on and off using the PWM control, thereby performing a control to cause the inverter 140 to (i) convert the direct current output from the physical storage unit 120 into a three-phase alternating current and (ii) output the three-phase alternating current. This control is performed according to, for example, an instruction from a drive system (not shown) of a vehicle in which the vehicle control system 100 is mounted. For example, the instruction may be given according to the number of revolutions of the motor when an accelerator is pressed by the user, a regenerative control performed when a brake is pressed by the user, or the like.

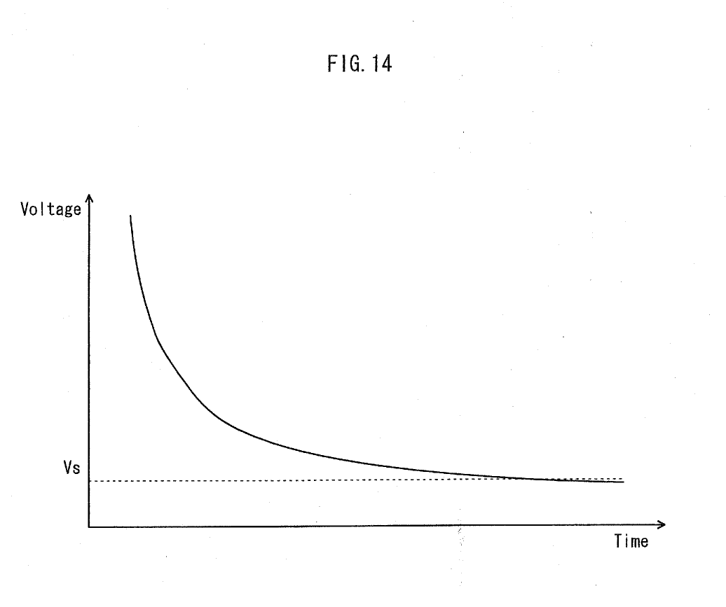

Also, when notified by the position determination unit 180 that the vehicle is approaching one of the parking positions, the control unit 190 detects a voltage Vc of the physical storage unit 120. Then, the control unit 190 determines whether the voltage Vc thus detected is higher than a predetermined voltage Vs. The voltage Vs is set within the range in which self-discharge of the physical storage unit 120 is suppressed. Referring to FIG. 14, the voltage Vs is set such that the rate of decrease (the inclination of the graph in FIG. 14) in the remaining voltage of the physical storage unit 120, which is caused by self-discharge of the physical storage unit 120, is less than or equal to a predetermined value. For example, the voltage Vs may be set such that the voltage of the physical storage unit 120 is substantially parallel to the horizontal axis of the graph (see “Vs” in FIG. 14). If determining that the voltage Vc is higher than the voltage Vs, the control unit 190 causes the charge and discharge circuit 130 to perform a charge operation. Specifically, the control unit 190 causes the switching device 132a of the charge and discharge circuit 130 to be switched on and off, so that an electric current flows from the physical storage unit 120 to the chemical storage unit 110. Details of the charge operation are described above. With the control described above, when the vehicle arrives at the destination, the voltage of the physical storage unit 120 is reduced below the voltage Vs at which self-discharge is suppressed.

Also, the control unit 190 stops a charge operation in the following case. Suppose that the control unit 190 starts a charge operation upon receiving a notification from the position determination unit 180 that the vehicle has approached a parking position, and thereafter receives a notification from the position determination unit 180 that the vehicle is moving away from the parking position. In this case, the control unit 190 stops the charge operation.

This concludes a description of the functional structure of the vehicle control system 100.

<Data>

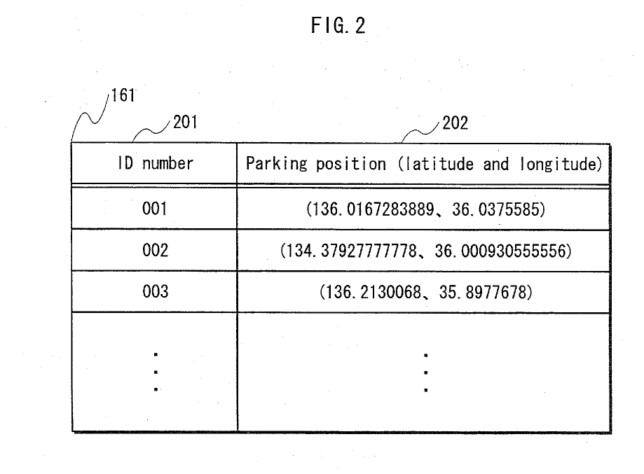

FIG. 2 is a data schematic view showing a specific example of the parking position information 161 stored in the parking position information storage unit 160.

As shown in FIG. 2, the parking position information 161 is information in which identification numbers 201 and parking positions 202 are in one-to-one correspondence.

The identification numbers 201 are provided for parking positions for the convenience of the vehicle control system 100 in managing and distinguishing each parking position.

Each of the parking positions 202 indicates the coordinates of a parking position designated as a destination of the vehicle, and is composed of the latitude and longitude of the parking position. In FIG. 2, the coordinates are expressed in the World Geodetic System (WGS).

The position determination unit 180 refers to the coordinates indicated by the parking positions 202 in the parking position information 161. When the vehicle approaches one of the parking positions, the position determination unit 180 determines that the vehicle is about to be parked, and the vehicle control system 100 starts controlling the use of the electric power of the physical storage unit 120.

<Operation>

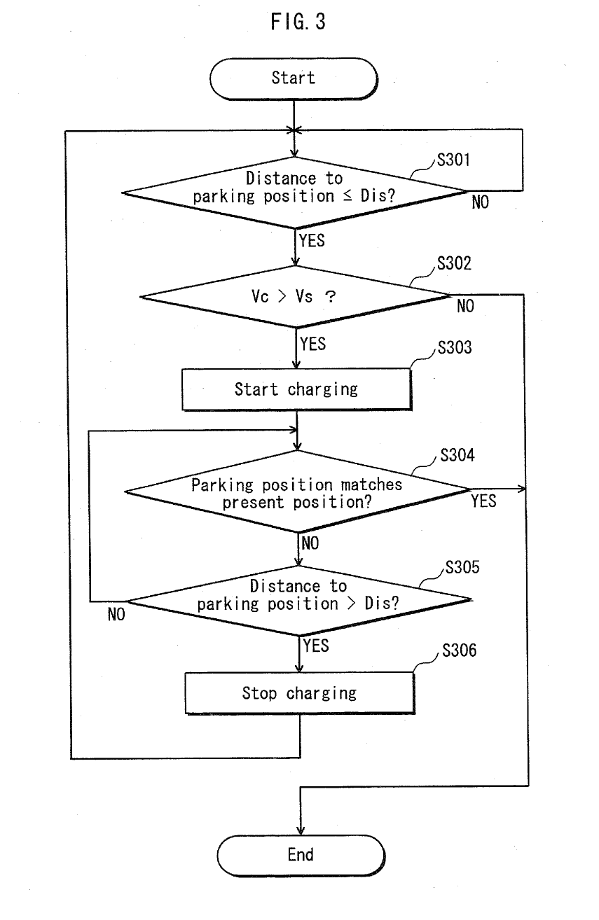

The following describes an operation of the vehicle control system 100, with reference to the flowcharts shown in FIGS. 3 to 5.

First, a description is provided of a control by which the vehicle control system 100 uses the electric power of the physical storage unit 120, with reference to FIG. 3. The processing shown by the flowchart in FIG. 3 is performed every time the position determination unit 180 receives present position information from the present position information acquisition unit 170.

Upon receiving present position information from the present position information acquisition unit 170, the position determination unit 180 calculates the distance between the present position indicated by the present position information and each parking position registered in the parking position information 161. The simplest way to determine the distance between the present position and a parking position is to calculate the square root of (X1²+Y1²)−(X2²+Y2²), where (X1, Y1) denote the coordinates of the present position and (X2, Y2) denote the coordinate of the parking position. It is possible to convert the unit of values thus calculated into another unit, etc. Then, the position determination unit 180 determines, for each distance thus calculated, whether the distance is less than or equal to the predetermined distance Dis stored in advance, i.e., determines whether the distance between the present position and any of the parking positions is less than or equal to the predetermined distance Dis (step S301).

If any of the distances thus calculated satisfies the above condition, i.e., the distance between the present position and any of the parking positions is less than or equal to the predetermined distance (YES in step S301), the position determination unit 180 gives the control unit 190 a notification that the vehicle is approaching the parking position. Upon receiving the notification, the control unit 190 detects the voltage Vc of the physical storage unit 120. Then, the control unit 190 determines whether the voltage Vc thus detected is greater than the voltage Vs, which is a predetermined voltage at which self-discharge of the physical storage unit 120 is suppressed (step S302).

If determining that the voltage Vc is greater than the voltage Vs (YES in step S302), the control unit 190 performs a charge operation from the physical storage unit 120 to the chemical storage unit 110 before the vehicle arrives at the parking position, by switching on and off the switching device 132a of the charge and discharge circuit 130 so that the electric power flows from the physical storage unit 120 to the chemical storage unit 110 (step S303). The charge operation is performed before the vehicle arrives at the parking position and until the voltage of the physical storage unit 120 becomes less than or equal to the voltage Vs, at a charge current within the range in which the chemical storage unit 110 is not damaged or deteriorated.

Even after the charge operation starts, the position determination unit 180 determines whether the present position indicated by the present position information sequentially transmitted from the present position information acquisition unit 170 matches the parking position in the parking position information 161 (step S304).

If the parking position does not match the present position (NO in step S304), the position determination unit 180 determines whether the distance between the present position and the parking position is greater than or equal to the predetermined distance Dis (step S305).

If the position determination unit 180 determines that the distance between the present position and the parking position exceeds the predetermined distance Dis, the control unit 190 determines that the vehicle has moved away from the parking position, and causes the charge and discharge circuit 130 to stop the charge operation (step S306). Thereafter, the processing returns to step S301.

Note that if it is determined that the voltage Vc is less than or equal to the voltage Vs in step S302 (NO in step S302), or if the parking position matches the present position in step S304 (YES in step S304), the processing is ended.

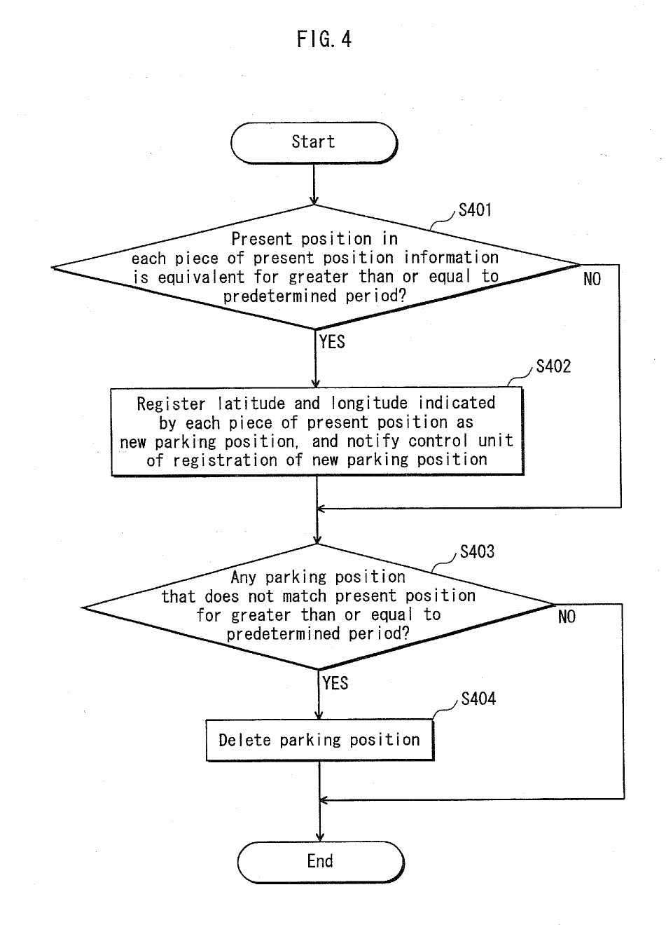

Next, a description is provided of the processing of the setting unit 185 regarding (i) registration of a parking position to the parking position information 161 and (ii) deletion of a parking position from the parking position information 161, with reference to the flowchart shown in FIG. 4. The processing shown by the flowchart of FIG. 4 is performed every time present position information is transmitted from the present position information acquisition unit 170 to the setting unit 185.

The setting unit 185 sequentially receives pieces of present position information from the present position information acquisition unit 170, records the history of the present position indicated by each piece of present position information, and determines whether the present position indicated by each piece of present position information is equivalent for greater than or equal to a predetermined time period (step S401). Here, the determination is performed by continuously determining whether a newly received piece of present position information matches a previous piece of present position information for the predetermined time period.

If determining that the present position indicated by each piece of present position information is equivalent for greater than or equal to the predetermined time period (YES in step S401), the setting unit 185 sets the latitude and longitude of the present position indicated by each piece of present position information as a new parking position, and additionally registers the new parking position in the parking position information 161. Also, the setting unit 185 notifies the control unit 190 that the new parking position has been registered (step S402). If determining that a piece of present position information newly received from the present position information acquisition unit 170 does not match a previous piece of present position information (NO in step S401), the processing proceeds to step S403.

Next, the setting unit 185 determines whether there is a parking position that does not match the present position for greater than or equal to a predetermined time period (step S403). The determination is performed by recording, for each parking position, information indicating the date and time at which the parking position last matched the present position indicated by the present position information, and determining whether the time difference between the recorded date and time and the present date and time is greater than the predetermined time period.

If determining that there is a parking position that does not match the present position for greater than or equal to the predetermined time period (YES in step S403), the setting unit 185 deletes the parking position from the parking position information 161, and ends the processing. If determining that there is no parking position that does not match the present position for greater than or equal to the predetermined time period (NO in step S403), the setting unit 185 ends the processing without performing any further step.

This completes the description of the processing of the setting unit 185 regarding registration and deletion of a parking position. Note that the flowcharts do not describe the processing performed upon receiving, from the user, an input specifying either registration or deletion of a parking position. However, as described above, the setting unit 185 registers the parking position to the parking position information 161 or deletes the parking position from the parking position information 161 depending on the input by the user.

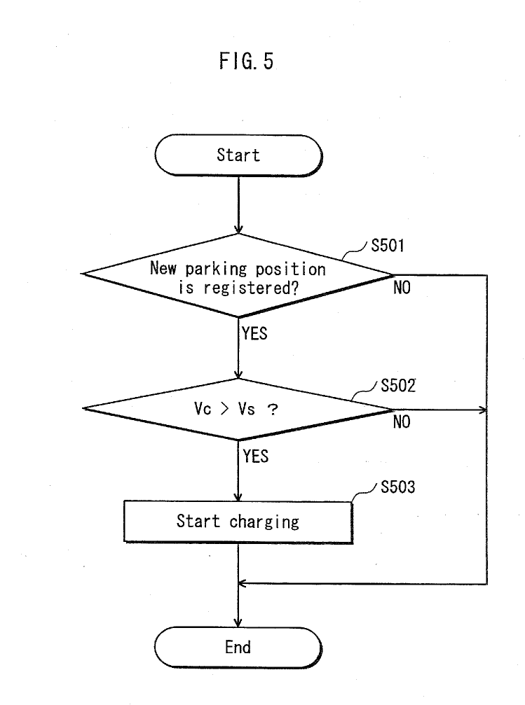

Next, a description is provided of the processing of the control unit 190 performed when the setting unit 185 has registered a new parking position, with reference to FIG. 5.

The control unit 190 determines whether a new parking position has been registered, based on whether the control unit 190 has been notified by the setting unit 185 that registration of the new parking position has been completed (step S501).

When notified by the setting unit 185 that registration of the new parking position has been completed (YES in step S501), the control unit 190 detects the voltage Vc of the physical storage unit 120. Then, the control unit 190 determines whether the voltage Vc is higher than the predetermined voltage Vs at which self-discharge of the physical storage unit 120 is suppressed (step S502).

If the voltage Vc of the physical storage unit 120 is higher than the predetermined voltage Vs (YES in step S502), the control unit 190 gives an instruction to the charge and discharge circuit 130 to start a charge operation and, accordingly, the charge and discharge circuit 130 performs the charge operation (step S503).

Provided that the setting unit 185 has newly registered a parking position, this means that the vehicle has been parked at the parking position. Therefore, if the remaining electric power of the physical storage unit 120 is higher than the predetermined electric power, the electric power of the physical storage unit 120 is supplied to the chemical storage unit 110. This suppresses an energy loss of the physical storage unit 120.

<Summary>

As described in Embodiment 1, when a vehicle in which the vehicle control system 100 is mounted approaches a parking position, which is a destination of the vehicle, the control unit 190 of the vehicle control system 100 gives an instruction to the charge and discharge circuit 130 to perform a charge operation from the physical storage unit 120 to the chemical storage unit 110. Therefore, by the time the vehicle arrives at the parking position, the voltage of the physical storage unit 120 is reduced to a voltage at which self-discharge is suppressed. This suppresses an energy loss of the physical storage unit 120 caused by self-discharge.

### Embodiment 2

In Embodiment 2, a vehicle control system is disclosed that performs an operation equivalent to the vehicle control system described in Embodiment 1, and that has a different structure from the vehicle control system in Embodiment 1.

<Structure>

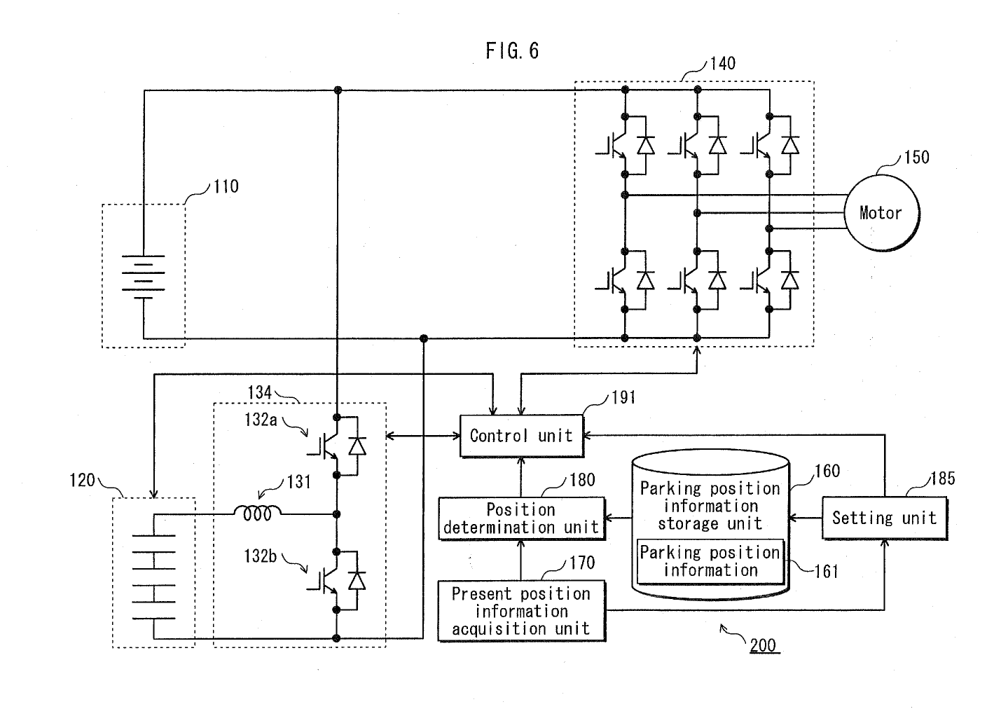

FIG. 6 shows the structure of a vehicle control system 200 according to Embodiment 2.

As can be seen from the comparison between FIG. 6 and FIG. 1, the vehicle control system 200 is different from the vehicle control system 100 in that the chemical storage unit 110 is directly connected to the inverter 140 without a charge and discharge circuit 134 therebetween. Also, the vehicle control system 200 is different in that the physical storage unit 120 is connected to the low-voltage side of the charge and discharge circuit 134, and the chemical storage unit 110 is connected to the high-voltage side of the charge and discharge circuit 134.

Furthermore, the vehicle control system 200 includes a control unit 191, instead of the control unit 190 in the vehicle control system 100.

The control unit 191 basically has a structure equivalent to the control unit 190, except that the control unit 191 causes different switching devices in the charge and discharge circuit 134 to be switched on and off during a charge operation and a discharge operation. In other words, when performing a charge operation from the physical storage unit 120 to the chemical storage unit 110, the control unit 191 switches on and off the switching device 132b. Also, when performing a discharge operation from the chemical storage unit 110 to the physical storage unit 120, the control unit 191 switches on and off the switching device 132a.

When a vehicle in which the vehicle control system 200 is mounted is started or accelerated, the control unit 191 in Embodiment 2 raises the voltage of the physical storage unit 120 and outputs the voltage equivalent to the voltage across the chemical storage unit 110, so that electric power is supplied from the charge and discharge circuit 134 to motor 150 via the inverter 140. At this time, the control unit 191 controls the inverter 140 such that the voltage output by the inverter 140 becomes equivalent to the voltage output by the charge and discharge circuit 134. Also, the control unit 191 switches on and off the switching device 132b to enable the physical storage unit 120 to output the electric power.

Specifically, the control unit 191 detects the electric current flowing through the inverter 140 and the voltage across the physical storage unit 120, and calculates the output power of the inverter 140. Then, the control unit 191 controls the charge and discharge circuit 134 such that the output power of the charge and discharge circuit 134 becomes equivalent to the output power of the inverter 140 thus calculated.

As an alternative method for the aforementioned control, the control unit 191 detects a charge current flowing through the chemical storage unit 110, and controls the output of the charge and discharge circuit 134 such that the value of the charge current flowing through the chemical storage unit 110 either becomes zero or falls within a predetermined current value. With this alternative method, the output power of the charge and discharge circuit 134 becomes equivalent to the input power of the inverter 140.

If a supply power from the physical storage unit 120 to the inverter 140 is smaller than a target electric power, the control unit 191 may increase the ON duty ratio of the switching device 132b. On the other hand, if the supply power is larger than the target electric power, the control unit 191 may decrease the ON duty ratio of the switching device 132b.

When the vehicle is decelerated, the inverter 140 performs a regenerative operation. The electric power regenerated by the inverter 140 is supplied to the physical storage unit 120 via the charge and discharge circuit 134. The control unit 191 controls the charge and discharge circuit 134, and thereby supplies, to the physical storage unit 120, an electric power equivalent to or greater than the electric power regenerated by the inverter 140 within the range in which the physical storage unit 120 is prevented from overvoltage. If a supply power from the inverter 140 to the physical storage unit 120 is smaller than a target electric power, the control unit 191 may increase the ON duty ratio of the switching device 132a. On the other hand, if the supply power is larger than the target electric power, the control unit 191 may decrease the ON duty ratio of the switching device 132a.

Note that the vehicle control system 200 performs control (see the flowcharts of FIGS. 3-5) similar to that performed by the vehicle control system 100 in Embodiment 1. Regarding the control, the only difference from Embodiment 1 is that when performing a charge operation, the control unit 191 switches on and off the switching device 132b in the charge and discharge circuit 134, instead of the switching device 132a. Therefore, it is considered that the control by the vehicle control system 200 in Embodiment 2 is equivalent to that by the vehicle control system 100 in Embodiment 1, and a detailed description of the control by the vehicle control system 200 is omitted.

<Summary>

The vehicle control system 200 in Embodiment 2 achieves the same effect as the vehicle control system 100 in Embodiment 1. According to the vehicle control system 200, by the time the vehicle arrives at a parking position, the voltage of the physical storage unit 120 is reduced to a voltage at which self-discharge of the physical storage unit 120 is suppressed.

### Embodiment 3

Embodiment 1 discloses a method for supplying electric power (charging) from the physical storage unit to the chemical storage unit, as a usage pattern of the electric power of the physical storage unit. Embodiment 3 discloses another usage pattern of the electric power of the physical storage unit.

<Structure>

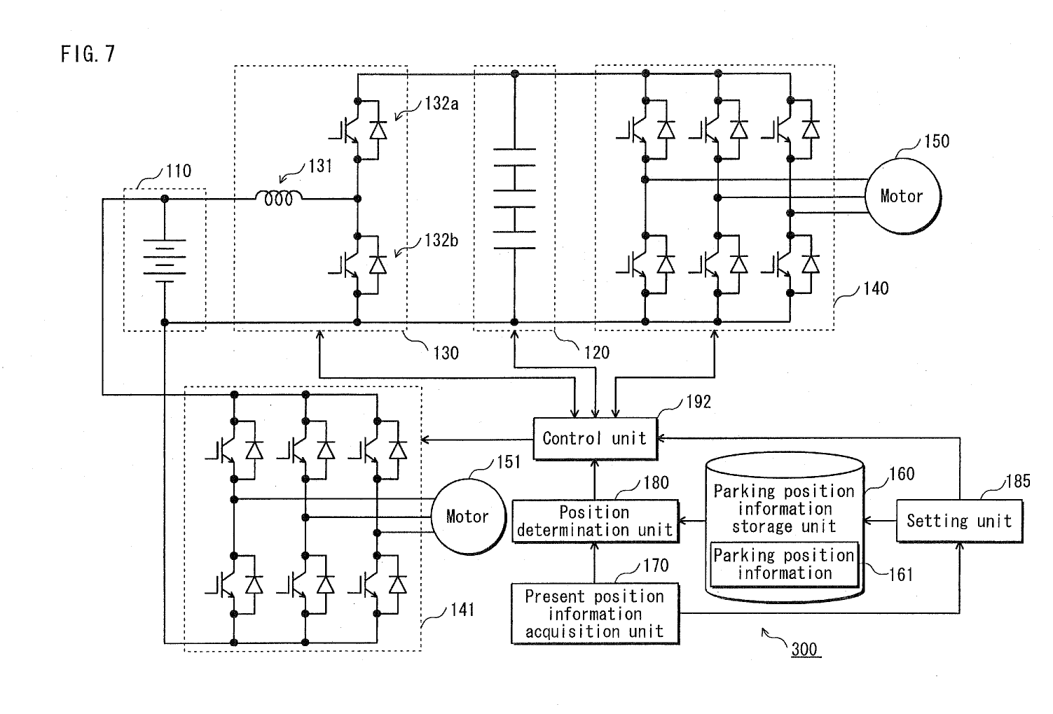

FIG. 7 shows the structure of a vehicle control system 300 according to Embodiment 3.

As shown in FIG. 7, in addition to the structure of the vehicle control system 100 in Embodiment 1, the vehicle control system 300 further includes an air conditioner inverter 141 and an air conditioner motor 151, both of which are for use in an air conditioner. The inverter 141 is directly connected to the chemical storage unit 110.

Furthermore, the vehicle control system 300 includes a control unit 192, instead of the control unit 190 in Embodiment 1.

The air conditioner inverter 141 receives electric power from the chemical storage unit 110, generates an alternating current from the electric power by switching on and off switching devices with the PWM control by the control unit 192, and outputs the alternating current to the air conditioner motor 151.

The air conditioner motor 151 is rotated by receiving an alternating current from the air conditioner inverter 141, and drives a compressor of the air conditioner.

The control unit 192 has the following functions in addition to those of the control unit 190 in Embodiment 1.

When both of the conditions in steps S301 and S302 in FIG. 3 are satisfied, the control unit 192 switches on and off the switching devices of the inverter 140 and the air conditioner inverter 141. At the same time, the control unit 192 gives an instruction to the charge and discharge circuit 130 to switch on and off the switching device 132a so as to supply an electric current from the physical storage unit 120 to the chemical storage unit 110.

This concludes a description of the functional structure of the vehicle control system 300.

<Operation>

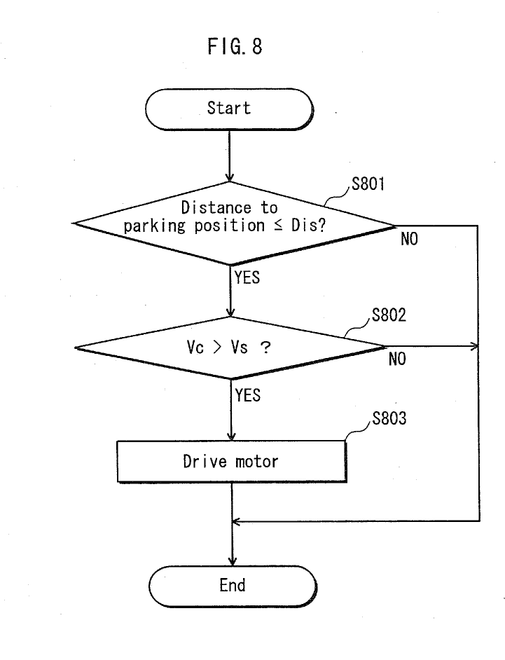

FIG. 8 is a flowchart pertaining to a control performed by the vehicle control system 300 when a vehicle in which the vehicle control system 300 is mounted approaches a parking position. The operations in steps S801 and S802 are the same as those in steps S301 and S302 in FIG. 3. Therefore, a description of the operations in steps S801 and S802 is omitted.

When (i) the distance between the present position and at least one of the parking positions registered in the parking position information 161 is less than or equal to the distance Dis and (ii) the voltage Vc of the physical storage unit 120 is higher than the predetermined voltage Vs (YES in step S801 and YES in step S802), the control unit 192 gives an instruction to the charge and discharge circuit 130 to switch on the switching device 132a, and performs on/off control on both the switching devices of the inverter 140 and the switching devices of the air conditioner inverter 141. In this way, the electric power of the physical storage unit 120 is used by the inverter 140 and the air conditioner inverter 141. Accordingly, the electric power stored in the physical storage unit 120 is consumed, resulting in the voltage of the physical storage unit 120 being reduced to the voltage Vs at which self-discharge is suppressed.

<Summary>

As described in Embodiment 3, the vehicle control system 300 reduces the voltage of the physical storage unit 120 using a method different from performing a charge operation from the physical storage unit 120 to the chemical storage unit 110. This makes it possible to reduce an energy loss of the physical storage unit 120 caused by self-discharge.

### Embodiment 4

In Embodiment 1, electric power is supplied (charged) from the capacitor, which is the physical storage unit, to the secondary battery, which is the chemical storage unit, when the condition is satisfied that the voltage of the capacitor is higher than the voltage Vs at which self-discharge of the capacitor is suppressed. Embodiment 4 discloses a vehicle control system that performs the charge operation under a condition different from the aforementioned condition.

<Structure>

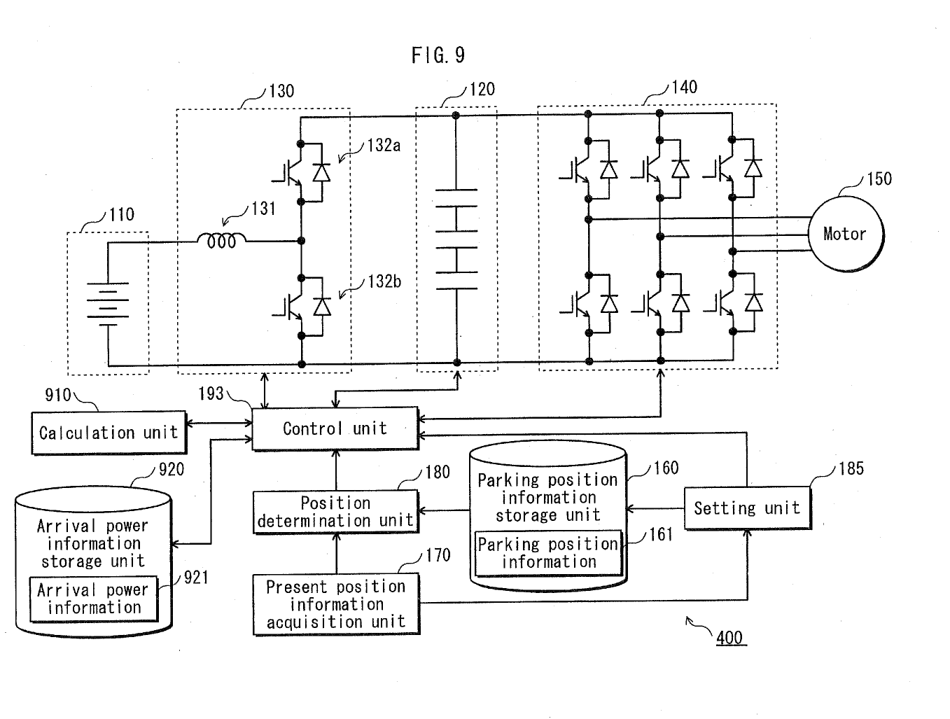

FIG. 9 shows the structure of a vehicle control system 400 according to Embodiment 4. As shown in FIG. 9, the vehicle control system 400 includes a calculation unit 910 and an arrival power information storage unit 920, in addition to the components of the vehicle control system 100.

Also, the vehicle control system 400 includes a control unit 193, instead of the control unit 190 in the vehicle control system 100.

The rest of the structure of the vehicle control system 400 is the same as the structure of the vehicle control system 100; therefore, a description thereof is omitted.

The control unit 193 performs control similar to that of the control unit 190. However, the control unit 193 is different from the control unit 190 on the following point. As shown in step S302 of the flowchart in FIG. 3 of Embodiment 1, the control unit 190 compares the voltage Vc of the physical storage unit 120 with the voltage Vs at which self-discharge of the physical storage unit 120 is suppressed. If the voltage Vc is larger than the voltage Vs, the control unit 190 performs a charge operation. On the other hand, the control unit 193 calculates the remaining electric power of the physical storage unit 120 when notified by the position determination unit 180 that a vehicle in which the vehicle control system 400 is mounted is approaching a parking position. If the electric power thus calculated is greater than an arrival power, which is an electric power necessary for the vehicle to travel from a position from which the distance to the parking position is less than or equal to the distance Dis to the parking position, the control unit 193 switches on and off the switching device 132a of the charge and discharge circuit 130, so as to supply electric power from the physical storage unit 120 to the chemical storage unit 110.

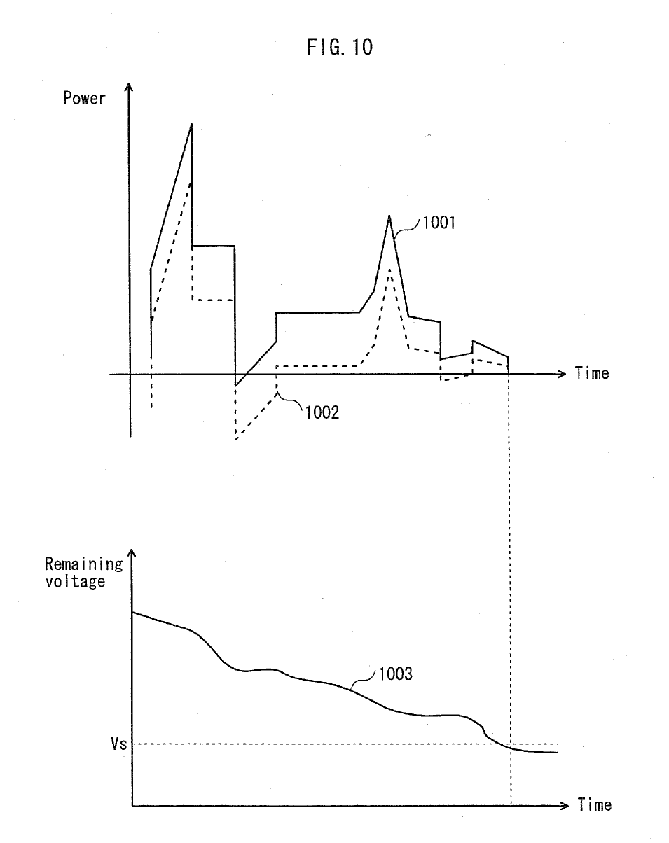

The following describes the relationship between an amount of arrival power and the voltage of the physical storage unit 120, with reference to FIG. 10.

The graph in the upper half of FIG. 10 shows an example of the change of electric power over time, the electric power being output by the charge and discharge circuit 130 and the inverter 140 during the time period from when the vehicle is at a position from which the distance to the parking position is less than or equal to the distance Dis until the vehicle arrives at the parking position. A solid line 1001 indicates the electric power output by the charge and discharge circuit 130 to the inverter 140 and the chemical storage unit 110, with the physical storage unit 120 being as a power source. Also, a dashed line 1002 indicates the electric power supplied by the inverter 140 to the motor 150 for moving the vehicle.

As shown in FIG. 10, the electric power necessary for moving the vehicle increases when the vehicle is started or accelerated, and decreases when the vehicle is decelerated. Also, deceleration of the vehicle triggers a regenerative operation. The portion at which the electric power indicated by the dashed line 1002 is negative corresponds to the time period in which a regenerative operation is being performed by the motor 150.

The graph in the lower half of FIG. 10 corresponds to the graph in the upper half of FIG. 10, and shows, by a solid line 1003, an example of the change of the remaining voltage of the physical storage unit 120. As shown in the graph in the lower half of FIG. 10, by the time the vehicle arrives at a parking position, which is a destination of the vehicle, the voltage of the physical storage unit 120 is less than or equal to the voltage Vs at which self-discharge of the physical storage unit 120 is suppressed.

The following describes in detail the structure for comparing the remaining electric power of the physical storage unit 120 and the arrival power, which is an amount of electric power necessary for the vehicle to arrive at the parking position.

When the distance between the present position notified by the present position information acquisition unit 170 and any of the parking positions indicated by the parking position information 161 is less than or equal to the distance Dis, the position determination unit 180 notifies the control unit 193 to that effect, i.e., that the vehicle is approaching the parking position. At this time, the position determination unit 180 also notifies the control unit 193 of the identification number, in the parking position information 161, corresponding to the parking position the vehicle is approaching so as to indicate which parking position the vehicle is approaching.

The calculation unit 910 receives a voltage value from the control unit 193, calculates a remaining electric power Ec of the physical storage unit 120, and notifies the control unit 193 of the remaining electric power Ec thus calculated. The calculation is performed by dividing the product of the capacitance of the physical storage unit 120 and the square of the voltage value notified by the control unit 193 by two. The capacitance of each capacitor connected in series, such as those of the physical storage unit 120, is calculated from the inverse of the sum of the inverse of each capacitor connected in series.

The arrival power information storage unit 920 is a recording medium realized by a nonvolatile HDD (Hard Disc Drive), a flash memory, or the like, and stores thereon arrival power information 921. The arrival power information 921 indicates, for each parking position registered in the parking position information 161, an amount of electric power (i.e., arrival power) necessary for the vehicle to arrive at the parking position. Details of the arrival power information 921 are described later.

When notified by the position determination unit 180 that the vehicle is approaching a parking position, the control unit 193 detects the voltage of the physical storage unit 120 and notifies the calculation unit 910 of the voltage. In response to the notification, the calculation unit 910 transmits the value of the remaining electric power Ec of the physical storage unit 120 to the control unit 193. Upon receiving the value of the remaining electric power Ec, the control unit 193 searches the arrival power information 921 stored in the arrival power information storage unit 920 for an amount of arrival power Eh corresponding to the parking position the vehicle is approaching, based on the identification information of the parking position notified by the position determination unit 180. Then, the control unit compares the remaining electric power Ec with the amount of arrival power Eh obtained by the search. If the remaining electric power Ec calculated by the calculation unit 910 is larger than the amount of arrival power Eh, the control unit 193 causes the charge and discharge circuit 130 to perform a charge operation from the physical storage unit 120 to the chemical storage unit 110. In other words, the control unit 193 switches on and off the switching device 132a.

Also, the control unit 193 measures an amount of electric power (i.e., arrival power) necessary for the vehicle to arrive at a parking position, and registers the amount of electric power in the arrival power information 921. Furthermore, every time the control unit 193 measures an amount of arrival power, the control unit 193 updates the arrival power information 921 with use of the amount of arrival power thus measured. When given a notification that the distance from the present position to a parking position is less than or equal to a predetermined distance, the control unit 193 calculates the electric power (including supply of electric power from the motor 150 by a regenerative operation) used by the physical storage unit 120 in order to move the vehicle, without supply of electric power from the chemical storage unit 110 by a discharge operation. The calculation is performed based on (i) the voltage value of the physical storage unit 120 when the notification was given and (ii) the voltage value of the physical storage unit 120 when the vehicle arrived at the parking position. Subsequently, if the arrival power information 921 does not include an amount of arrival power corresponding to the parking position, the control unit 193 registers the amount of arrival power thus measured in the arrival power information 921. If the arrival power information 921 includes an amount of arrival power corresponding to the parking position, the control unit 193 updates the amount of arrival power with the average of amounts of arrival power. The average of amounts of arrival power is obtained by adding the amount of arrival power thus measured to each amount of arrival power measured in the past, and dividing the total amount of arrival power by the number of times an amount of arrival power has been measured so far. The control unit 193 measures an amount of arrival power for each parking position, for each predetermined number of times the vehicle travels toward the parking position.

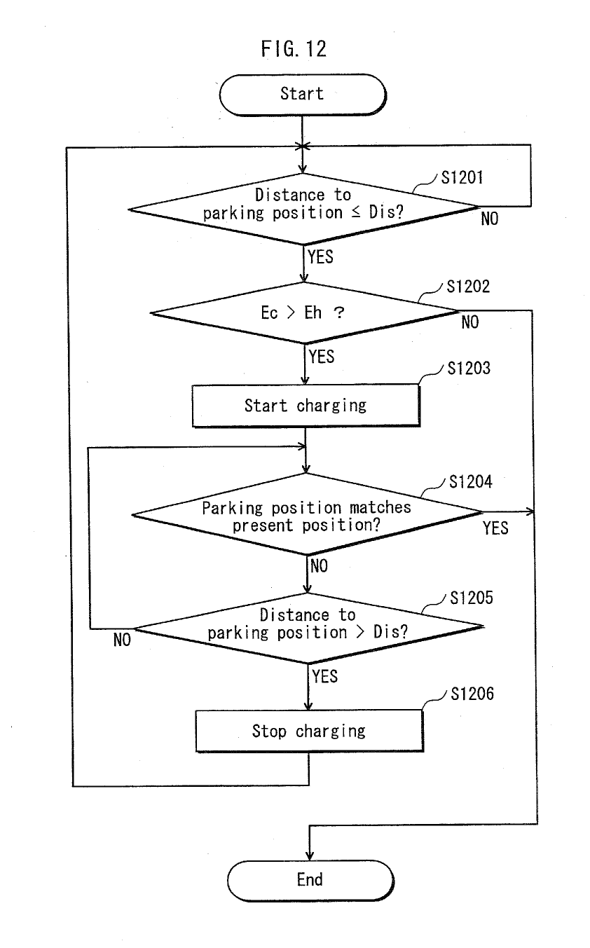

With the function of measuring an amount of arrival power, the control unit 193 achieves the following advantageous effect. Suppose that the setting unit 185 newly registers a parking position in the parking position information 161. Even in such a case, the control unit 193 measures an amount of electric power (i.e., arrival power) necessary for the vehicle to arrive at the newly registered parking position, and registers the amount of electric power thus measured in the arrival power information 921. After the registration in the arrival power information 921, the control unit 193 is able to perform the aforementioned control. Note that when the control unit 193 measures an amount of arrival power, it is preferable that the control unit 193 does not perform a charge operation shown in FIG. 12, i.e., a charge operation from the physical storage unit 120 to the chemical storage unit 110, in order to accurately measure the amount of arrival power.

<Data>

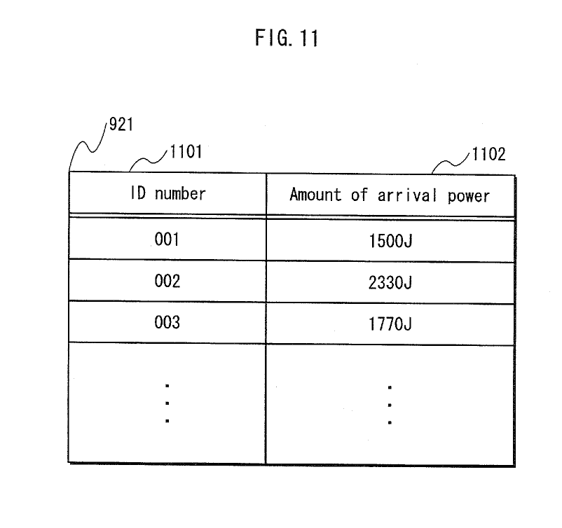

FIG. 11 is a data schematic view showing an example of the structure of the arrival power information 921.

As shown in FIG. 11, the arrival power information 921 is information in which identification numbers 1101 and amounts of arrival power 1102 are in one-to-one correspondence.

The identification numbers 1101 are provided for the amounts of arrival power 1102 for the convenience of the vehicle control system in managing and distinguishing each amount of arrival power. The identification numbers 1101 correspond to the identification numbers 201 in the parking position information 161.

Each of the amounts of arrival power 1102 indicates an amount of electric power necessary for the vehicle to arrive at a parking position identified by the corresponding identification number 1101. Each of the amounts of arrival power 1102 is the average of amounts of arrival power measured a plurality of times, during the time period from when the distance between the present position and a parking position identified by the corresponding identification number 1101 is less than or equal to the predetermined distance Dis until the present position matches the parking position. Since the identification numbers 1101 correspond to the identification numbers 201 of the parking position information 161, the amounts of arrival power 1102 indicate the amounts of electric power necessary for the vehicle to arrive at the respective parking positions.

<Operation>

FIG. 12 is a flowchart showing a charge operation of the vehicle control system 400 from the physical storage unit 120 to the chemical storage unit 110, according to Embodiment 4.

The flowchart of FIG. 12 is substantially the same as the flowchart of FIG. 3 according to Embodiment 1. Therefore, the following only describes a difference from FIG. 3. The flowchart of FIG. 12 is different from the flowchart of FIG. 3 with respect to step S1202.

When notified by the position determination unit 180 that the vehicle is approaching a parking position, together with the identification number corresponding to the parking position (YES in step S1201), the control unit 193 detects the voltage Vc of the physical storage unit 120. Then, the control unit 193 notifies the calculation unit 910 of the voltage Vc thus detected. Based on the voltage value Vc, the calculation unit 910 calculates a remaining electric power Ec of the physical storage unit 120, and notifies the control unit 193 of the remaining electric power Ec. The remaining electric power Ec is calculated from the following formula: C×Vc²×0.5, where C denotes the capacitance of the physical storage unit 120. Upon receiving the remaining electric power Ec, the control unit 193 extracts, from the arrival power information 921, the amount of arrival power Eh corresponding to the identification number notified by the position determination unit 180, and determines whether the remaining electric power Ec received from the calculation unit 910 is larger than the amount of arrival power Eh by comparing the remaining electric power Ec with the amount of arrival power Eh (step S1202).

If determining that the remaining electric power Ec is larger than the amount of arrival power Eh (YES in step S1202), the control unit 193 switches on and off the switching device 132a of the charge and discharge circuit 130, thereby performing a charge operation from the physical storage unit 120 to the chemical storage unit 110. If determining that the remaining electric power Ec is less than or equal to the amount of arrival power Eh (NO in step S1202), the processing is ended.

<Summary>

According to the vehicle control system 400 in Embodiment 4, a charge operation from the physical storage unit 120 to the chemical storage unit 110 is performed when the following two conditions are satisfied: (i) the distance from the present position of the vehicle in which the vehicle control system 400 is mounted to a parking position is less than or equal to the predetermined distance Dis; and (ii) the remaining electric power in the physical storage unit 120 is larger than the amount of electric power necessary for the vehicle to arrive at the parking position. In other words, based on the precondition that the vehicle control system 400 uses the electric power of the physical storage unit 120 to drive the motor in order for the vehicle to travel from the present position to the parking position, the chemical storage unit 110 is charged with the electric power obtained by subtracting, from the electric power of the physical storage unit 120, the electric power necessary for the travel to the parking position. This ensures that the voltage of the physical storage unit 120 is less than or equal to the voltage Vs when the vehicle approaches the parking position. Also, if the remaining electric power in the physical storage unit 120 is less than or equal to the amount of electric power necessary for the vehicle to arrive at the parking position, charging of the chemical storage unit 110 is not performed. As a result, charging of the chemical storage unit 110 is performed less frequently. This makes it possible to provide a vehicle control system including the chemical storage unit 110 having a long life.

### Embodiment 5

In each of Embodiments 1 to 4 above, a description is provided of a vehicle control system. However, in Embodiment 5, a brief description is provided of an automobile in which the vehicle control system is mounted.

<Structure>

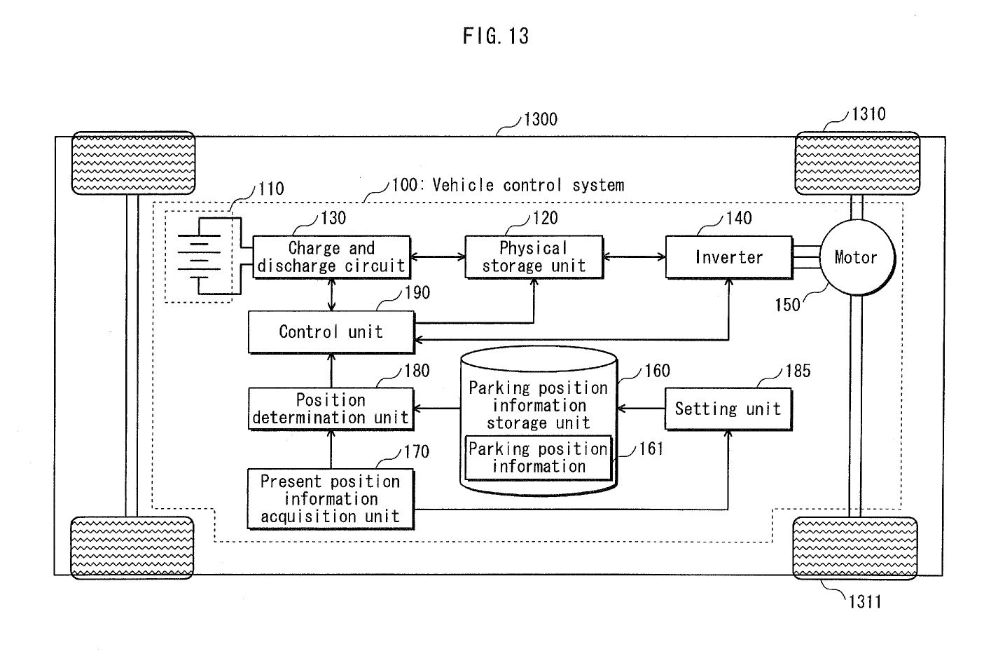

FIG. 13 shows the structure of an automobile 1300.

As shown in FIG. 13, the automobile 1300 includes the vehicle control system 100 and wheels 1310 and 1311.

Since the vehicle control system 100 is the same as that described in Embodiment 1, a detailed description thereof is omitted.

The motor 150 of the vehicle control system 100 is attached to an axle for driving the wheels 1310 and 1311. The rotation of the motor 150 causes the axle to rotate, which causes the wheels 1310 and 1311 to rotate, enabling the automobile 1300 to move.

As described above, the vehicle control system 100 drives the wheels of the automobile 1300. Note that although not shown in FIG. 13, the automobile 1300 further includes a mechanism that automobiles have in general, such as a control mechanism in which the direction of the automobile is determined with use of a steering wheel.

<Supplementary Remark 1>

Although the present invention has been described based on the above embodiment, the present invention is of course not limited to such. In addition to the above embodiment, the present invention includes the following modifications.

(1) The vehicle control system may perform the control described in Embodiment 1 in combination with the control described in Embodiment 4.

That is, the predetermined distance Dis, which is used by the position determination unit to determine whether the vehicle is approaching a destination, may take a different value depending on whether it is used in the control described in Embodiment 1 or the control described in Embodiment 4. Then, the position determination unit may first perform the control described in Embodiment 4 to perform a charge operation, and thereafter perform the control described in Embodiment 1.

This structure has the following advantage. For example, suppose that even after the control described in Embodiment 4, electric power is not consumed as planned due to a weather condition, a different travel path, or the like. Even in such a case, the voltage of the physical storage unit is reliably reduced to the voltage Vs or less by the control in Embodiment 1.

(2) The above embodiments describe that the chemical storage unit 110 is a secondary battery, and is realized by a nickel hydride battery, a lithium-ion battery, or the like. However, the chemical storage unit 110 may be realized by another battery, such as a fuel cell.

In this case, however, the fuel cell cannot be charged from the physical storage unit. Accordingly, the electric power of the physical storage unit may be used for controlling the motor for moving the vehicle, the motor for driving the air conditioner, etc., instead of being used for charging, so as to reduce the voltage of the physical storage unit to the voltage Vs or less, as shown in Embodiments 3 and 4.

(3) According to the above embodiments, the setting unit 185 sequentially receives pieces of present position information from the present position information acquisition unit 170. Then, if the present position indicated by each piece of present position information is equivalent for greater than or equal to the predetermined time period, the setting unit 185 registers the present position as a new parking position into the parking position information 161. However, the trigger for the registration does not always need to be the predetermined time period. For example, the registration may be performed when the setting unit 185 receives a present position information piece indicating the same present position for a predetermined number of times.

(4) In the above embodiments, a GPS is used as a method for acquiring the present position of the vehicle. However, a different method may be employed as long as it enables determining whether the vehicle is approaching a parking position. For example, the vehicle control system may include the following function instead of a GPS. That is, the vehicle control system may access a base station or the like which is located closest to the vehicle within a mobile telephone network, and acquire, from the base station, area information indicating the communicable range of the base station. If any of the parking positions indicated by the parking position information is included in the area information, the vehicle control system may determine that the vehicle has approached the parking position.

(5) In the above embodiments, the vehicle control system includes the present position information acquisition unit 170. However, if the vehicle includes a car navigation system, the car navigation system may acquire, as the present position information, position information with use of a GPS.

(6) Embodiment 3 gives an example in which the electric power of the physical storage unit 120 is used to drive the motors. In a case where the electric power is used to drive the motor 150, which is a motor for moving the vehicle, the control unit 190 may perform control for preventing the electric power from flowing from the chemical storage unit 110 to the physical storage unit 120. For example, the control unit 190 may perform control for switching on the switching device 132a.

(7) The above embodiments mention that the setting unit 185 determines whether to register a parking position using the predetermined time period, but did not mention how to determine the predetermined time period. The following provides an example of how to determine the predetermined time period.

When a charge operation is performed by the charge and discharge circuit 130 (131), the power loss of the charge and discharge circuit 130 (131) occurs. Accordingly, if the charge and discharge circuit 130 (131) performs a charge operation when the parking duration is short, the power loss of the charge and discharge circuit 130 (131) may become greater than the energy loss caused by self-discharge of the physical storage unit 120. This is because the power loss of the charge and discharge circuit 130 (131) is caused by both a charge operation performed before the vehicle arrives at a parking position and a discharge operation performed when the vehicle starts moving again from the parking position. Therefore, the time period used for determining whether to register a parking position as a destination is determined based on a result of comparison between (i) the power loss caused by the charge and discharge operations of the charge and discharge circuit 130 (131) and (ii) the energy loss defined by the speed of self-discharge of the physical storage unit 120. The time period used for determining whether to register a parking position may be determined as described above.

(8) In the above embodiments, a charge operation is performed when the distance between the present position and a parking position becomes less than or equal to the predetermined distance Dis. However, there may be a case where the vehicle in which the vehicle control system is mounted moves around in the vicinity of an area away from the parking position by the distance Dis.

Therefore, in the vehicle control system, the distance Dis may be set to be relatively long. Then, another step may be inserted between step S301 and step S302 in the flow of FIG. 3. In the inserted step, a determination is made as to whether a predetermined time period has elapsed since the distance to the parking position became less than or equal to the distance Dis. If it is determined that the predetermined time period has elapsed, the determination of step S302 is made. If it is determined affirmatively in step S302, a charge operation is performed. At this time, the predetermined time period is preferably set to be shorter than the time period required for the vehicle to arrive at the parking position. For example, it is possible to measure the time required for the vehicle to travel the distance Dis and set the predetermined time period to be shorter than the measured time.

This prevents a repetition of the start and end of a charge operation caused by the vehicle moving around the vicinity of the area away from the parking position by distance Dis.

(9) According to Embodiment 4 above, an amount of arrival power registered in the arrival power information 921 is the average of amounts of electric power that are each used by the vehicle to arrive at a parking position in the past. However, in order to reliably reduce the voltage of the physical storage unit 120 to the voltage Vs or less, the least amount of electric power among the amounts of electric power used in the past may be registered as the amount of arrival power.

(10) According to Embodiment 5 above, the vehicle control system 100 in Embodiment 1 is mounted in the automobile 1300. However, it is possible that any of the vehicle control systems 200, 300, and 400 is mounted in the automobile 1300. Alternatively, a combination of these vehicle control systems may be mounted in the automobile 1300.

(11) In the above embodiments, the position determination unit 180 calculates the distance in a straight line between the present position and the parking position. However, position determination unit 180 may acquire the route from the present position to the parking position, from a car navigation system of a vehicle in which the vehicle control system is mounted, and calculate the distance of the route as the distance between the present position and the parking position.

(12) The arrival power information 921 in Embodiment 4 may further include time th associated with each identification number. The time th indicates, for each parking position, the time taken by the vehicle from when the distance from the present position to the parking position becomes less than or equal to the distance Dis until the vehicle arrives at the parking position. Then, the control unit 193 may switch on and off the switching device 132a of the charge and discharge circuit 130, in a manner that the electric power obtained by dividing a difference Ec−Eh by the time th is gradually consumed. Here, the difference Ec−Eh is a difference between the electric power Ec and the electric power Eh. With this structure, the chemical storage unit 110 is charged at constant current, thus preventing a damage or deterioration of the chemical storage unit 110. Note that each time th may be the average of the lengths of time taken by the vehicle to arrive at the corresponding parking position. Alternatively, each time th may be the shortest length of time among the lengths of time taken by the vehicle to arrive at the corresponding parking position. This enables the control unit 193 to control the remaining voltage of the physical storage unit 120 (i.e., perform a charge operation and drive the motor) before the vehicle arrives at a parking position, in a manner that the voltage of the physical storage unit 120 becomes less than or equal to the predetermined voltage at which self-discharge of the physical storage unit 120 is suppressed.

(13) Each of the vehicle control systems in the above embodiments may further include a prevention circuit between the chemical storage unit 110 and the physical storage unit 120. The prevention circuit prevents discharge from the chemical storage unit 110 to the physical storage unit 120. The discharge is likely to occur when the voltage of the physical storage unit 120 is lowered due to the chemical storage unit 110 being charged from the physical storage unit 120 in step S303 described above, etc.

(14) Each of the functional components and the circuits in the configuration diagrams used in the above embodiments (FIGS. 1, 6, 7, 9, 13, etc.) may be integrated into one or more LSIs (Large Scale Integration). Also, two or more of the functional components may be realized by one LSI.

Each of the LSIs may be referred to as an IC (Integrated Circuit), a system LSI, a VLSI (Very Large Scale Integration), an SLSI (Super Large Scale Integration), an ULSI (Ultra Large Scale Integration), and so on, in accordance with the degree of integration.

Furthermore, if a technology of integration that replaces the LSIs emerges from advancement of semiconductor technology or other derivative technology, such a technology can be used for the integration of the functional blocks. For instance, biotechnology may be adapted as such a technology.

(15) A control program composed of program codes may be recorded on a recording medium or distributed via various communication channels or the like, the program codes being for causing a processor in the vehicle control system, etc. and various circuits connected to the processor to perform the operations pertaining to use of the electric power of the physical storage unit, a charge operation, registration and deletion of a parking position (see FIGS. 3, 4, 5, 8, 12), etc. shown in the above embodiments. Examples of the recording medium include an IC card, a hard disk, an optical disc, a flexible disk, and a ROM. The control program thus distributed may be stored in a processor-readable memory or the like so as to be available for use. The functions described in the above embodiments are realized by a processor executing the control program.

<Supplementary Remark 2>

The following describes aspects of the present invention and advantageous effects thereof.

The present invention provides a vehicle control system including: a chemical storage unit; a physical storage unit; and a charge and discharge circuit connected between the chemical storage unit and the physical storage unit and transferring electric power therebetween, the vehicle control system comprising: a parking position information storage unit capable of storing therein at least one parking position information piece indicating a parking position of a vehicle in which the vehicle control system is mounted; a present position information acquisition unit configured to sequentially acquire present position information pieces each indicating a present position of the vehicle; a position determination unit configured to determine whether a distance between the present position and the parking position is less than or equal to a predetermined distance; and a control unit configured, when the position determination unit determines affirmatively, to control use of the electric power of the physical storage unit before the vehicle arrives at the parking position.

Also, the present invention provides an automobile comprising: a chemical storage unit; a physical storage unit; a charge and discharge circuit, connected between the chemical storage unit and the physical storage unit, and configured to transfer electric power between the chemical storage unit and the physical storage unit, a parking position information storage unit capable of storing therein at least one parking position information piece indicating a parking position of the automobile; a present position information acquisition unit configured to sequentially acquire present position information pieces each indicating a present position of the automobile; a position determination unit configured to determine whether a distance between the present position and the parking position is less than or equal to a predetermined distance; a control unit configured, when the position determination unit determines affirmatively, to control use of the electric power of the physical storage unit before the automobile arrives at the parking position; an inverter configured to receive electric power from one of the chemical storage unit and the physical storage unit, and to output an alternating current; a motor configured to rotate upon receiving the alternating current; and a wheel configured to be driven by the motor.

The present invention provides an electric power control method in a vehicle control system including: a chemical storage unit; a physical storage unit; a charge and discharge circuit connected between the chemical storage unit and the physical storage unit and transferring electric power therebetween; a parking position information storage unit capable of storing therein at least one parking position information piece indicating a parking position of a vehicle in which the vehicle control system is mounted; the electric power control method comprising: an acquisition step of sequentially acquiring present position information pieces each indicating a present position of the vehicle; a determination step of determining whether a distance between the present position and the parking position is less than or equal to a predetermined distance; and a control step of, when the determination step determines affirmatively, controlling use of the electric power of the physical storage unit before the vehicle arrives at the parking position.

Here, the predetermined distance corresponds to the predetermined distance Dis in the above embodiments.

With the stated structure, the control unit controls the use of the electric power of the physical storage unit when the vehicle in which the vehicle control system is mounted approaches the parking position indicated by the parking position information piece. This suppresses self-discharge of the physical storage unit after the vehicle stops, resulting in an energy loss being more efficiently suppressed than in the conventional technologies. Also, suppose that the electric power of the physical storage unit is used to charge the chemical storage unit. Even in such a case, the control of the use of the electric power of the physical storage unit is performed only when the vehicle approaches the predetermined parking position. This prevents charging from being performed every time the vehicle stops, thus preventing the life of the chemical storage unit from being wastefully shortened.

Also, the predetermined distance may be a distance traveled by the vehicle for a time period necessary for the control unit to reduce, with use of the electric power of the physical storage unit, the voltage of the physical storage unit at least to a predetermined voltage.

Alternatively, the control unit may perform the control in a manner that the voltage of the physical storage unit becomes less than or equal to a predetermined voltage.

Here, the predetermined voltage corresponds to the voltage Vs in the above embodiments.

With the stated structure, the voltage of the physical storage unit is reliably reduced to the predetermined voltage by the time the vehicle arrives at the parking position. This suppresses an energy loss caused by self-discharge of the physical storage unit. For example, the predetermined voltage may be set to the voltage Vs mentioned in the above embodiments, so that the voltage of the physical storage unit is reliably reduced to the voltage at which self-discharge of the physical storage unit is suppressed.

Also, the control unit may perform the control by causing the charge and discharge circuit to supply electric power from the physical storage unit to the chemical storage unit.

In this case, the predetermined distance may be a distance traveled, by the vehicle in which the vehicle control system is mounted, for a time period that is sufficient enough to reduce the voltage of the physical storage unit to the predetermined voltage or less by supplying electric power from the physical storage unit to the chemical storage unit at an electric current that does not cause damage or deterioration of the chemical storage unit.

In this way, when the vehicle approaches the parking position indicated by the parking position information piece, electric power is supplied from the physical storage unit to the chemical storage unit, i.e., the chemical storage unit is charged with the electric power of the physical storage unit. Accordingly, the electric power stored in the physical storage unit is reduced, and the voltage thereof is reduced as well. Also, since the electric power corresponding to the reduction in electric power in the physical storage unit is used to charge the chemical storage unit, an energy loss of the physical storage unit is suppressed as well.

Also, the vehicle control system may further comprise: a motor for driving a wheel; and an inverter configured to receive a direct current and supply, to the motor, an alternating current for rotating the motor, wherein the control unit performs the control by causing the charge and discharge circuit to supply part of the electric power of the physical storage unit to the chemical storage unit and causing the inverter to supply part of a remaining electric power of the physical storage unit to the motor.

Alternatively, the vehicle control system may further comprise: a motor for driving a wheel; and an inverter configured to receive a direct current and supply, to the motor, an alternating current for rotating the motor, wherein the control unit may perform the control by causing the inverter to supply electric power from the physical storage unit to the motor.

With the stated structure, when the vehicle in which the vehicle control system is mounted approaches the parking position indicated by the parking position information piece, the electric power stored in the physical storage unit is consumed by use in driving the motor, i.e., moving the vehicle. This reduces the voltage of the physical storage unit and suppresses a wasteful energy loss.

Also, the vehicle control system may further comprise: an arrival power information storage unit storing therein information indicating an amount of arrival power, which is an amount of electric power consumed from when the position determination unit determines that the distance between the present position and the parking position is less than or equal to the predetermined distance until the present position matches the parking position; and a calculation unit configured to calculate an amount of electric power consumed by the physical storage unit until a current voltage of the physical storage unit becomes equivalent to a predetermined voltage, wherein when the amount of electric power calculated by the calculation unit is larger than the amount of arrival power, the control unit may perform the control by causing the charge and discharge circuit to supply part of the electric power of the physical storage unit to the chemical storage unit and causing the inverter to supply part of a remaining electric power of the physical storage unit to the motor.

Here, the predetermined voltage corresponds to the voltage Vs in the above embodiments.

With the stated structure, when the vehicle in which the vehicle control system is mounted approaches the parking position indicated by the parking position information piece, the remaining electric power of the physical storage unit is compared to the amount of arrival power stored in advance. This makes it possible to determine whether to control the use of the remaining electric power of the physical storage unit. Suppose that the electric power stored in the physical storage unit is used to drive the vehicle. In this case, if the remaining electric power of the physical storage unit is greater than or equal to the amount of arrival power, which is an amount of electric power necessary for the vehicle to arrive at the parking position, the control of the use of the electric power of the physical storage unit may be further performed. In this way, the voltage of the physical storage unit is reduced to the predetermined voltage or less. Also, provided that the predetermined voltage is set to the voltage Vs mentioned in the above embodiments, the voltage of the physical storage unit can be reduced to the voltage at which self-discharge of the physical storage unit is suppressed.

Also, the vehicle control system may further comprise: an arrival power information storage unit storing therein information indicating an amount of arrival power, which is an amount of electric power consumed from when the position determination unit determines that the distance between the present position and the parking position is less than or equal to the predetermined distance until the present position matches the parking position; a calculation unit configured to calculate an amount of electric power consumed by the physical storage unit until a current voltage of the physical storage unit becomes equivalent to a predetermined voltage; and an air conditioner inverter configured to supply electric power to an air conditioner, wherein when the amount of electric power calculated by the calculation unit is larger than the amount of arrival power, the control unit may perform the control by causing the air conditioner inverter to supply electric power from the physical storage unit to the air conditioner.

Here, the predetermined voltage corresponds to the voltage Vs in the above embodiments.

With the stated structure, when the vehicle in which the vehicle control system is mounted approaches the parking position indicated by the parking position information piece, the electric power stored in the physical storage unit is used to drive the air conditioner motor. This reduces the voltage of the physical storage unit, and suppresses an energy loss of the physical storage unit.

Also, the vehicle control system may further comprise a setting unit configured, when the present position indicated by each of the present position information pieces is equivalent for a predetermined time period, to store, into the parking position information storage unit, the present position as a new parking position information piece.

With the stated structure, the vehicle control system can automatically register a parking position without receiving an input from the user, i.e., without troubling the user.

Also, the vehicle control system may further comprise a setting unit configured to store, into the parking position information storage unit, a parking position specified by a user as a new parking position information piece.

With the stated structure, the vehicle control system can register a parking position desired by the user.

Also, when the present position does not match the parking position indicated by the parking position information piece for the predetermined time period, the setting unit may delete the parking position information piece from the parking position information storage unit.

With the stated structure, the vehicle control system can automatically delete a parking position information piece without receiving an input from the user, i.e., without troubling the user.

Also, upon storing the new parking position information piece into the parking position information storage unit, the setting unit may notify the control unit of the storage, and when the control unit is notified that the new parking position information piece has been stored, and that the voltage of the physical storage unit exceeds a predetermined voltage, the control unit may perform the control by causing the charge and discharge circuit to supply electric power from the physical storage unit to the chemical storage unit.

Here, the predetermined voltage corresponds to the voltage Vs in the above embodiments.

According to the vehicle control system having the stated structure, when a new parking position is registered, and the voltage of the physical storage unit exceeds the predetermined voltage, the chemical storage unit is charged from the physical storage unit. This suppresses an energy loss caused by self-discharge of the physical storage unit.

Also, the parking position information storage unit may be capable of storing therein a plurality of parking position information pieces each indicating a parking position of the vehicle, the position determination unit may determine, for each parking position, whether a distance between the present position and the parking position is less than or equal to the predetermined distance, and the control unit may perform the control when the position determination unit determines affirmatively regarding any of the parking positions.

With the stated structure, the vehicle control system can store therein a plurality of parking position information pieces indicating respective parking positions, and control, for each parking position, the use of the electric power of the physical storage unit, i.e., controls the reduction of the voltage of the physical storage unit.

### INDUSTRIAL APPLICABILITY

A vehicle control system according to the present invention is applicable to a hybrid car or an electric car, as a system capable of minimizing self-discharge of a physical storage unit, such as a capacitor, and suppressing drain of a chemical storage unit, such as a secondary battery.

### REFERENCE SIGNS LIST

100, 200, 300, and 400 vehicle control system
110 chemical storage unit
120 physical storage unit
130 and 134 charge and discharge circuit
131 inductor
132a and 132b switching device
140 inverter
141 air conditioner inverter
150 motor
151 air conditioner motor
160 parking position information storage unit
170 present position information acquisition unit
180 position determination unit
185 setting unit
190, 191, 192, and 193 control unit
910 calculation unit
920 arrival power information storage unit
1300 automobile
1310 and 1311 wheel

1-17. (canceled)

18. A vehicle control system including: a chemical storage unit; a physical storage unit; and a charge and discharge circuit connected between the chemical storage unit and the physical storage unit and transferring electric power therebetween, the vehicle control system comprising:
a parking position information storage unit capable of storing therein at least one parking position information piece indicating a parking position of a vehicle in which the vehicle control system is mounted;
a present position information acquisition unit configured to sequentially acquire present position information pieces each indicating a present position of the vehicle;
a position determination unit configured to determine whether a distance between the present position and the parking position is less than or equal to a predetermined distance; and
a control unit configured, when the position determination unit determines affirmatively, to control use of the electric power of the physical storage unit in priority to the electric power of the chemical storage unit before the vehicle arrives at the parking position, such that a voltage of the physical storage unit becomes less than or equal to a voltage at which self-discharge of the physical storage unit is suppressed.

19. The vehicle control system of claim 18 wherein
the predetermined distance is a distance traveled by the vehicle for a time period necessary for the control unit to reduce, with use of the electric power of the physical storage unit, the voltage of the physical storage unit at least to the voltage at which self-discharge of the physical storage unit is suppressed.

20. The vehicle control system of claim 18 wherein
the control unit performs the control by causing the charge and discharge circuit to supply electric power from the physical storage unit to the chemical storage unit.

21. The vehicle control system of claim 20, further comprising:
a motor for driving a wheel; and
an inverter configured to receive a direct current and supply, to the motor, an alternating current for rotating the motor, wherein
the control unit performs the control by causing the charge and discharge circuit to supply part of the electric power of the physical storage unit to the chemical storage unit and causing the inverter to supply part of a remaining electric power of the physical storage unit to the motor.

22. The vehicle control system of claim 18, further comprising:
a motor for driving a wheel; and
an inverter configured to receive a direct current and supply, to the motor, an alternating current for rotating the motor, wherein
the control unit performs the control by causing the inverter to supply electric power from the physical storage unit to the motor.

23. The vehicle control system of claim 21, further comprising:
an arrival power information storage unit storing therein information indicating an amount of arrival power, which is an amount of electric power consumed from when the position determination unit determines that the distance between the present position and the parking position is less than or equal to the predetermined distance until the present position matches the parking position; and
a calculation unit configured to calculate an amount of electric power consumed by the physical storage unit until a current voltage of the physical storage unit becomes equivalent to the voltage at which self-discharge of the physical storage unit is suppressed, wherein
when the amount of electric power calculated by the calculation unit is larger than the amount of arrival power, the control unit performs the control by causing the charge and discharge circuit to supply part of the electric power of the physical storage unit to the chemical storage unit and causing the inverter to supply part of a remaining electric power of the physical storage unit to the motor.

24. The vehicle control system of claim 21, further comprising:
an arrival power information storage unit storing therein information indicating an amount of arrival power, which is an amount of electric power consumed from when the position determination unit determines that the distance between the present position and the parking position is less than or equal to the predetermined distance until the present position matches the parking position;
a calculation unit configured to calculate an amount of electric power consumed by the physical storage unit until a current voltage of the physical storage unit becomes equivalent to the voltage at which self-discharge of the physical storage unit is suppressed; and
an air conditioner inverter configured to supply electric power to an air conditioner, wherein
when the amount of electric power calculated by the calculation unit is larger than the amount of arrival power, the control unit performs the control by causing the air conditioner inverter to supply electric power from the physical storage unit to the air conditioner.

25. The vehicle control system of claim 18, further comprising
a setting unit configured, when the present position indicated by each of the present position information pieces is equivalent for a predetermined time period, to store, into the parking position information storage unit, the present position as a new parking position information piece.

26. The vehicle control system of claim 18, further comprising
a setting unit configured to store, into the parking position information storage unit, a parking position specified by a user as a new parking position information piece.

27. The vehicle control system of claim 25 wherein
when the present position does not match the parking position indicated by the parking position information piece for the predetermined time period, the setting unit deletes the parking position information piece from the parking position information storage unit.

28. The vehicle control system of claim 26 wherein
when the present position does not match the parking position indicated by the parking position information piece for the predetermined time period, the setting unit deletes the parking position information piece from the parking position information storage unit.

29. The vehicle control system of claim 25 wherein
upon storing the new parking position information piece into the parking position information storage unit, the setting unit notifies the control unit of the storage, and
when the control unit is notified that the new parking position information piece has been stored, and that the voltage of the physical storage unit exceeds the voltage at which self-discharge of the physical storage unit is suppressed, the control unit performs the control by causing the charge and discharge circuit to supply electric power from the physical storage unit to the chemical storage unit.

30. The vehicle control system of claim 26 wherein
upon storing the new parking position information piece into the parking position information storage unit, the setting unit notifies the control unit of the storage, and
when the control unit is notified that the new parking position information piece has been stored, and that the voltage of the physical storage unit exceeds the voltage at which self-discharge of the physical storage unit is suppressed, the control unit performs the control by causing the charge and discharge circuit to supply electric power from the physical storage unit to the chemical storage unit.

31. The vehicle control system of claim 18 wherein
the parking position information storage unit is capable of storing therein a plurality of parking position information pieces each indicating a parking position of the vehicle,
the position determination unit determines, for each parking position, whether a distance between the present position and the parking position is less than or equal to the predetermined distance, and
the control unit performs the control when the position determination unit determines affirmatively regarding any of the parking positions.

32. An automobile comprising:
a chemical storage unit;
a physical storage unit;
a charge and discharge circuit, connected between the chemical storage unit and the physical storage unit, and configured to transfer electric power between the chemical storage unit and the physical storage unit,
a parking position information storage unit capable of storing therein at least one parking position information piece indicating a parking position of the automobile;
a present position information acquisition unit configured to sequentially acquire present position information pieces each indicating a present position of the automobile;
a position determination unit configured to determine whether a distance between the present position and the parking position is less than or equal to a predetermined distance;
a control unit configured, when the position determination unit determines affirmatively, to control use of the electric power of the physical storage unit in priority to the electric power of the chemical storage unit before the automobile arrives at the parking position, such that a voltage of the physical storage unit becomes less than or equal to a voltage at which self-discharge of the physical storage unit is suppressed;
an inverter configured to receive electric power from one of the chemical storage unit and the physical storage unit, and to output an alternating current;
a motor configured to rotate upon receiving the alternating current; and
a wheel configured to be driven by the motor.

33. An electric power control method in a vehicle control system including: a chemical storage unit; a physical storage unit; a charge and discharge circuit connected between the chemical storage unit and the physical storage unit and transferring electric power therebetween; a parking position information storage unit capable of storing therein at least one parking position information piece indicating a parking position of a vehicle in which the vehicle control system is mounted; the electric power control method comprising:
an acquisition step of sequentially acquiring present position information pieces each indicating a present position of the vehicle;
a determination step of determining whether a distance between the present position and the parking position is less than or equal to a predetermined distance; and
a control step of, when the determination step determines affirmatively, controlling use of the electric power of the physical storage unit in priority to the electric power of the chemical storage unit before the vehicle arrives at the parking position, such that a voltage of the physical storage unit becomes less than or equal to a voltage at which self-discharge of the physical storage unit is suppressed.
